(19) United States
(12) Patent Application Publication
(10) Pub. No.: US 2022/0402162 A1
(43) Pub. Date: Dec. 22, 2022

(54) FINES INTERFACE LAYER FOR IMPROVED ENGINEERED WOOD PRODUCTS

(71) Applicant: LOUISIANA-PACIFIC CORPORATION, NASHVILLE, TN (US)

(72) Inventors: GARETH PAUL MERRICK, GIG HARBOR, WA (US); BRIAN ST. GERMAIN, MT. JULIET, TN (US); LANCE OLSON, SAGINAW, MN (US)

(21) Appl. No.: 17/843,544

(22) Filed: Jun. 17, 2022

Related U.S. Application Data
(60) Provisional application No. 63/211,587, filed on Jun. 17, 2021.
(60) Provisional application No. 63/214,299, filed on Jun. 24, 2021.

(51) Int. Cl. B27N 3/12; B27N 3/20; B27N 3/06

(52) U.S. Cl. CPC B27N 3/12; B27N 3/203; B27N 3/06

(57) ABSTRACT

An engineered wood based siding, cladding or panel with a fines interface layer between the main strand matrix layers and the fines layer to minimize telegraphing and provide an improved surface appearance. The fines interface layer is applied to the surface of the strand matrix or mat prior to application of the fines layer. The FIL sits between the strand matrix and the fines layer, and prevents the loss of fines into the strand matrix. The FIL thus keeps the fines at the surface so they can effectively and efficiently function to prevent or eliminate strand telegraphing, and provide a smooth finished surface for the product.

This application claims benefit of and priority to U.S. Provisional Application Nos. 63/211,587, filed Jun. 17, 2021, and 63/214,299, filed Jun. 24, 2021. The complete disclosures, including all specifications, drawings, and appendices, of U.S. Provisional Application No. 63/211,587 (filed Jun. 17, 2021); No. 63/214,299 (filed Jun. 24, 2021); and No. 63/276,913 (filed Nov. 8, 2021) are incorporated herein in their entireties by specific reference for all purposes.

### FIELD OF INVENTION

This invention relates to a system and process for producing an engineered wood based siding, cladding or panel (e.g., manufactured with wood veneer, strands or fibers) with an interface layer between the main strand layers and the fines layer to minimize telegraphing and improve the appearance of the final product.

### SUMMARY OF INVENTION

This invention relates comprises a method or process for producing an engineered wood based siding, cladding or panel (e.g., manufactured with wood veneer, strands or fibers) with a fines interface layer (i.e., an interface layer between the main strand layers and the fines layer) to minimize telegraphing and provide an improved surface appearance.

Prior art processes typically apply a “fines layer” to the surface of the multi-layer strand matrix or mat during the manufacturing process. The fines in the fines layers comprise “wood flour” or small particles of wood, typically a by-product from the strand processing. This functional fines layer is added to help minimize telegraphing of strands or flakes on the surface of the siding or finished product. However, a portion of the fines fall into open spaces or voids in the strand matrix, which reduces the effectiveness of the fines layer in resisting strand telegraphing.

In various exemplary embodiments, a “fines interface layer” (or FIL) is applied to the surface of the strand matrix or mat prior to application of the fines layer. The FIL sits between the strand matrix and the fines layer, and prevents the loss of fines into the strand matrix. The FIL thus keeps the fines at the surface so they can effectively and efficiently function to prevent or eliminate strand telegraphing, and provide a smooth finished surface for the product.

The FIL may comprise a fabric (such as, but not limited to, a woven or non-woven synthetic or natural material), specialty papers, resin-saturated or resin-impregnated papers, pulp mats, glue (adhesive) films, plastic films, minerals, or similar materials that can be used to separate the strand matrix or mat and the fines layer. The material used for the FIL should be compatible with the particular manufacturing process, i.e., compatible with any adhesive, additives, heat and/or pressure that may be used. In some embodiments, for example, the manufacturing process comprises high temperatures and pressure. In several embodiments, the fabric should be able to withstand high temperatures up to 230 degrees F. While in some embodiments the FIL may be chosen to withstand high temperatures and pressure, in alternative embodiments the FIL may be chosen so that the manufacturing process produces changes in the form or configuration of the FIL material (e.g., melting or flowing). Thus, for example, the FIL material may comprise glass or glass-like material, including, but not limited to, binding material that partially or fully melts, flows and/or bonds (adheres) during the pressing process.

In other embodiments, a stiffening material is added to the FIL, so that the FIL becomes stiffer and stronger during the pressing process, and helps provide additional strength and stiffness to the final product itself. In further exemplary embodiments, the FIL material may be selected due to natural material properties, such as, but not limited to, fire resistance, fungal resistance, moisture/water resistance, sound dampening, or the like. Alternatively, or in addition, the FIL may be treated to provide or enhance such properties.

### BRIEF DESCRIPTION OF THE DRAWINGS

FIG. 1 shows a top partial view of a manufactured wood product with a fines interface layer (FIL) between a multi-layered strand matrix and a functional fines layer (not to scale).

FIG. 2 shows a partial side view of FIG. 1 (not to scale).

FIG. 3 shows a diagram of a method in accordance with the present invention.

### DETAILED DESCRIPTION OF EXEMPLARY EMBODIMENTS

In various exemplary embodiments, the present invention comprises a method or process for producing an engineered wood based siding, cladding or panel 2 (e.g., manufactured with wood veneer, strands or fibers) with a fines interface layer (i.e., an interface layer between the main strand layers and the fines layer) to minimize telegraphing and provide an improved surface appearance.

Engineered wood products (such as OSB, LSL, LVL, or plywood) typically are produced by various primary (and sometimes secondary) pressing processes. Examples of such processes are in U.S. Pat. Nos. 6,461,743; 5,718,786; 5,525,394; 5,470,631; and 5,425,976; and U.S. patent application Ser. No. 15/803,771; all of which are incorporated herein in their entireties by specific reference for all purposes.

The nature of the engineered wood manufacturing process results in inherent sub-surface and surface defects or imperfections. Sub-surface defects often result in visible defects or imperfections on the surface (commonly referred to as “telegraphing”). Deeply or aggressively embossed or textured surfaces often can distract the eye from noticing these imperfections, but smooth (non-embossed or minimally embossed) surfaces are more susceptible to having this telegraphing become noticeable, especially under critical light conditions. This is a particular problem with engineered wood based smooth surface siding or cladding when installed on a building, where varying light conditions and viewing angles make undesirable surface imperfections noticeable.

During the manufacturing of strand-based engineered wood products, several formers (typically four, five or six) with orientation heads apply strands in multiple layers to a continuously moving conveyor belt. Each forming head will inevitably have a varying number of strands layered on top of one another to form an intertwined layer of stands. As each forming head operates independently from one another, the variation of the number of strands that is ultimately achieved in any one location in the final layered mat contains the combined variation of all the forming heads. This variation is advantageous in the pressing process as it helps to better facilitate the escape of volatilized water that is necessary to mold the strands together under high heat and pressure during the pressing process, resulting in a structural panel product. However, when using such products in an aesthetic application, such as exterior cladding, this variation in the number of strands that comprise the thickness of the product creates some challenges. As strands are still relatively large particles of wood, as compared to the fines used in other wood composites such as MDF (medium density fiberboard) and particleboard, an engineered wood product comprised of strands is still subject to the inherent properties of the wood itself.

One such property is the change in dimension in response to a change in moisture content. All wood species expand and contract at various levels in response to changing moisture conditions. This is largely due to the transport systems within the wood cell structure itself which are intended to carry water through a living tree. As strands are still large pieces of wood, these transport systems largely remain intact within each strand. With a varying number of strands within each location across the panel, and each strand responding with a change in dimension as moisture conditions change within the panel, there is the potential for differential thickness swell across the surface of any panel. In products that are used in aesthetic applications, such as exterior cladding, even subtle (i.e., less than 0.002″) differences in thickness can be seen by the naked eye in critical light conditions. Therefore, it becomes a requirement of utilizing a strand-based product in these aesthetic applications to effectively control this differential movement or strands from becoming visible in addition to the other inherent surface imperfections that occur in a strand based product manufacturing process.

One approach is the application of “fines layer” to the surface of the multi-layer strand matrix or mat during the manufacturing process. The fines in the fines layers comprise “wood flour” or small particles of wood, typically a by-product from the strand processing. This functional fines layer is added to help minimize telegraphing of strands or flakes on the surface of the siding or finished product. However, a portion of the fines fall into open spaces or voids in the strand matrix, which reduces the effectiveness of the fines layer in resisting strand telegraphing.

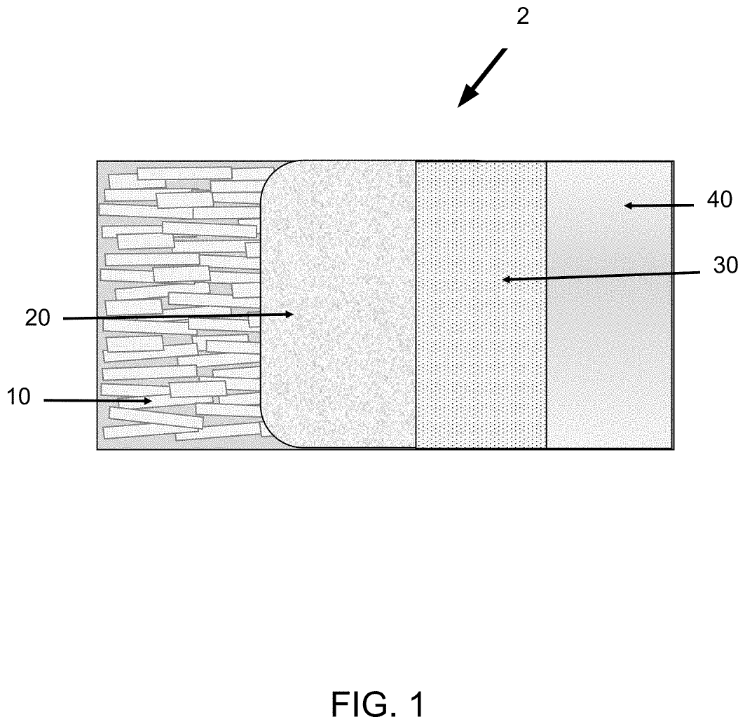

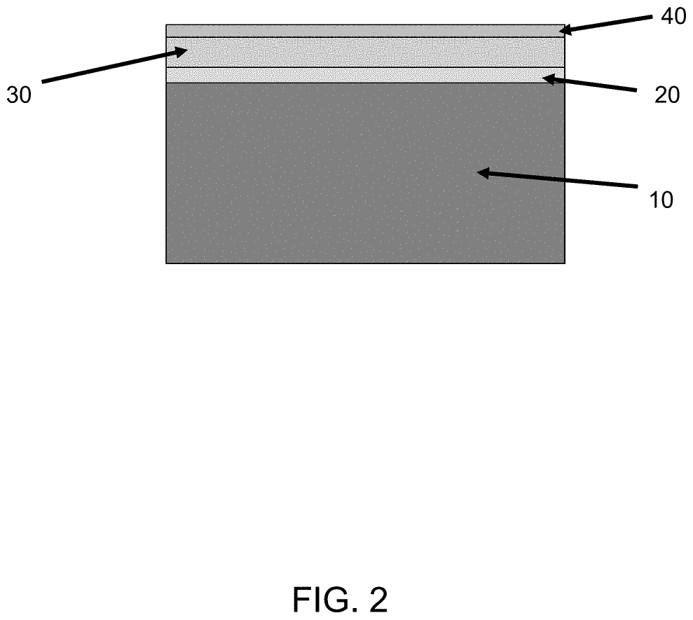

In various exemplary embodiments, as seen in FIGS. 1 and 2, a “fines interface layer” (or FIL) 20 is applied to the surface of the strand matrix or mat (e.g., a multi-layer strand matrix with proprietary alignment) 10 prior to application of the fines layer 30. The FIL sits between the strand matrix 10 and the fines layer (sometimes referred to as a functional fines layer) 30, and prevents the loss of fines into the strand matrix. The FIL thus keeps the fines at the surface so they can effectively and efficiently function to prevent or eliminate strand telegraphing, and provide a smooth finished surface for the product.

The FIL may comprise a fabric (such as, but not limited to, a woven or non-woven synthetic or natural material), specialty papers, resin-saturated papers, pulp mats, glue (adhesive) films, plastic films, minerals, or similar materials that can be used to separate the strand matrix or mat and the fines layer. The material should prevent the passage of the fines material, or the majority of the fines material, therethrough. In several embodiments, the material is impervious to the fines material.

The material used for the FIL should be compatible with the particular manufacturing process, i.e., compatible with any adhesive, additives, heat and/or pressure that may be used. In some embodiments, for example, the manufacturing process comprises high temperatures and pressure. In several embodiments, the material should be able to withstand high temperatures up to 230 degrees F. While in some embodiments the FIL may be chosen to withstand high temperatures and pressure, in alternative embodiments the FIL may be chosen so that the manufacturing process produces changes in the form or configuration of the FIL material (e.g., melting or flowing). Thus, for example, the FIL material may comprise glass or glass-like material, including, but not limited to, binding material that partially or fully melts, flows and/or bonds (adheres) during the pressing process.

In other embodiments, a stiffening material is added to the FIL, so that the FIL becomes stiffer and stronger during the pressing process, and helps provide additional strength and stiffness to the final product itself. In further exemplary embodiments, the FIL material may be selected due to natural material properties, such as, but not limited to, fire resistance, fungal resistance, moisture/water resistance, sound dampening, or the like. Alternatively, or in addition, the FIL may be treated to provide or enhance such properties.

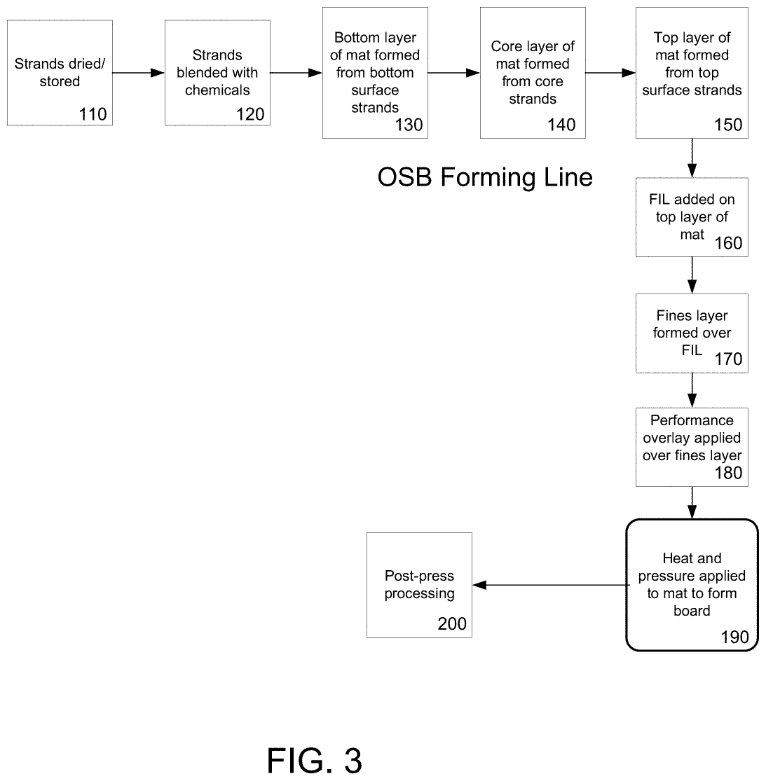

One exemplary method of production comprises the following steps. Strands/flakes are processed/treated (i.e., cut, dried, and stored 110), then treated and/or coated with adhesive and performance enhancing additives and chemicals (e.g., wax, resin, and the like) 120. Strands designated for particular layers may receive different treatment, although in some cases strands are treated identically regardless of intended layer. The strands are then used to form the appropriate layers in order (e.g., first bottom surface, then core, then top surface), by depositing the designated strands 130, 140, 150 onto the production or forming line to form a multi-layer mat or strand matrix. The number of layers typically varies from 2 to 5 layers (FIG. 3 shows 3 layers). The fines interface layer described above is then placed 160 on the upper surface of the mat, followed by application of the fines layer over the FIL 170. An overlay or performance overlay (such as, but not limited to, a paper overlay) 180 is then placed on top of the fines layer. The overlay may, for example, comprise a primed paper overlay with performance additives.

The assembled, unbonded layers are then subjected to further processing depending on the final product desired. Suitable adhesives include but are not limited to those selected from an isocyanate, phenolic, hot-melt polyurethane or melamine category alone or in combination. Pressure may be applied using several methods including but not limited to a hot press, cold press or steam-injection press. The process may be continuous or non-continuous (batch) or a combination or hybridization of these. Heat may be conveyed using various methods, to include but not be limited to steam, microwaves, thermal oil and the like.

For example, in one embodiment the assembled, unbonded layers are conveyed into a press for final consolidation and bonding under pressure. In another embodiment, as seen in FIG. 3, the assembled, unbonded layers are conveyed into a hot press 190 for final consolidation and bonding under heat and pressure. In yet another embodiment, the assembled, unbonded layers are subjected to microwaves with or without a heated platen. In a further embodiment, the assembled, unbonded layers are subjected to super-heated steam. After pressing, the resulting board may then be subject to further post-press processing 200 (e.g., additional overlays, secondary pressing or processing, trimming, sizing, priming, sealing, and packaging), depending on the desired final end product.

The present invention may be used with any engineered wood manufacturing process, regardless of the end-use application, and is not limited to siding. For example, it can be used with OSB manufactured as part of a “combination” product, such as, but not limited to, an OSB strand core with particleboard or fiberboard faces.

Similarly, FILs may be used on one or both faces or surfaces of a product (i.e., a two-surface smooth product). If a single FIL is used, it may be used on the bottom surface or top surface of the product. Thus, the FIL may be used on the top surface only, the bottom surface only, or on both surfaces. In the case of an FIL used on the bottom surface, the above-described method is modified to include a step of placing a bottom FIL on the forming or production line prior to the formation of the bottom layer of the mat 30 (the bottom layer of the mat is then formed on the bottom FIL).

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A improved method of producing an engineered wood product, comprising the steps of:
forming a multi-layer strand matrix on a production line, said strand matrix comprising a top surface;
applying a fines interface layer on the top surface of the strand matrix, said fines interface layer comprising an upper surface opposite the strand matrix;
forming a fines layer on the upper surface of the fines interface layer; and
consolidating and bonding the strand matrix, fines interface layer, and fine layer together using heat and/or pressure.

2. The method of claim 1, wherein the fines interface layer is configured to prevent the passage of fines from the fines layer into the strand matrix.

3. The method of claim 2, wherein the fines interface layer is configured to prevent the passage of the majority of fines from the fines layer into the strand matrix.

4. The method of claim 1, wherein the fines interface layer comprises fabric.

5. The method of claim 4, wherein the fabric is a non-woven synthetic or natural material.

6. The method of claim 4, wherein the fabric is a woven synthetic or natural material.

7. The method of claim 1, wherein the fines interface layer comprises a plastic film, or glue or adhesive film.

8. The method of claim 1, wherein the fines interface layer comprises paper.

9. The method of claim 8, wherein the fines interface layer comprises a resin-impregnated or resin-saturated paper.

10. The method of claim 1, wherein the fines interface layer partially or fully melts during the step of consolidating and bonding.

11. The method of claim 1, wherein the fines interface layer comprises a stiffener.

12. The method of claim 1, wherein the fines interface layer provides one or more of the following: fire resistance; fungal resistance; moisture resistance; and sound dampening.

13. The method of claim 1, further comprising the step of an applying an overlay on an upper surface of the fines layer opposite the fines interface layer.

14. The method of claim 1, wherein the step of consolidating and bonding comprises application of heat and pressure using a hot press.

15. The method of claim 1, wherein the step of consolidating and bonding comprises application of pressure using a cold press.

16. The method of claim 1, wherein the step of consolidating and bonding comprises application of microwaves with or without a heated platen.

17. The method of claim 1, wherein the step of consolidating and bonding comprises application of super-heated steam.

18. An engineered-wood product produced by the method of claim 1.

19. The product of claim 18, wherein the engineered-wood product is an Oriented-Strand Board (OSB) plank, board or panel.

20. The product of claim 18, wherein the engineered-wood product is a siding, cladding or panel.
